(19) United States
(12) Patent Application Publication
(10) Pub. No.: US 2019/0322503 A1
(43) Pub. Date: Oct. 24, 2019

(54) FORKLIFT FOR AIR TRANSPORT AND STOWAGE PROCEDURE

(71) Applicant: UP LIFTING VERTICAL, S.A., Cuarte, Huesca (ES)

(72) Inventor: Jose Antonio GARCES JIMENEZ, Cuarte, Zaragoza (ES)

(73) Assignee: UP LIFTING VERTICAL, S.A., Cuarte, Huesca (ES)

(21) Appl. No.: 16/311,398

(22) PCT Filed: Jun. 1, 2017
(86) PCT No.: PCT/ES2017/070394

§ 371 Date: Dec. 19, 2018

(30) Foreign Application Priority Data
Jul. 8, 2016 (ES) P201630938

(51) Int. Cl. B66F 9/06

(52) U.S. Cl. CPC B66F 9/06

(57) ABSTRACT

A forklift capable of being transported in an Airbus A400 or higher with the capacity to go up/down the aeroplane ramp without the need to use supports or props, both in the stowage position in the hold of the aeroplane and in the operations of climbing/descending by ancillary ramps preserving the structural integrity of the machine complying with the allowable limits of maximum weight per axle according to the distance between them. The forklift has a folding counterweight envisaged for the distribution of the weight on the rear axle and locking/unlocking device between the mast and chassis envisaged for the distribution of the weight on the front axle thereby reducing the weight per axle to below the established limits in the hold of the aeroplane.

### OBJECT OF THE INVENTION

This invention belongs to the field of manufacturers of machinery for lifting heavy loads, in particular, the invention relates to an air-transportable forklift equipped with structural devices that enable the allowable weight per axle to be redistributed, to facilitate its air transportation, maintaining the structural integrity of the machine.

The basic aim of the invention is to develop a forklift capable of being transported in an Airbus A400 or higher, with the capacity to go up the aeroplane ramp, without the need to use of supports or props both in the stowage position in the hold of the aeroplane and in the operations of climbing/descending from the aeroplane by means of ancillary ramps, complying with the allowable limits of maximum weight per axle and distance between them, for which purpose the said forklift comprises a folding counterweight, envisaged for the distribution of the weight on the rear axle, and locking/unlocking means between the mast and chassis, envisaged for the distribution of the weight on the front axle, thereby reducing the weight per axle to below 10,000 kg, which is the maximum allowable weight in the hold of the aeroplane.

### BACKGROUND OF THE INVENTION

Currently there is the need to transport general cargo forklifts of up 20 tonnes by air, in aeroplanes such as, for example, the Airbus A400 or higher, with the drawback that the weight of the forklift must be within the allowable limits of the hold of the aeroplane.

Thus, depending on the distance between the axles of the forklift to be transported, the allowed weight per axle must be 10,000 kg, for which a device has to be applied to allow the distribution or reduction of the weight of the axles, since the forklift of the characteristics that is intended to be transported has a much higher weight per axle, approximately 15,000 kg per axle.

Seeking other solutions envisaged for the transportation of forklifts, patent ES2018676 describes a forklift built to be as compact and light as possible, being foldable and apt for the universal international chassis dimensions of platform trucks and similar, the said forklift being envisaged to be placed under a truck or semi-trailer or trailer with the lowest possible mounting height, this solution being designed for road transport only, and without considering the distribution of weights.

Another example, described in patent ES2408304, is a forklift for mounting on the rear of a transport vehicle, with an accessory for the lateral displacement of the fork, but with the drawback that it has to be dismantled.

### DESCRIPTION OF THE INVENTION

To resolve the aforementioned drawbacks, an air-transportable forklift has been devised that basically comprises a chassis supported by a front axle, a rear axle and a mast with fork, incorporating structural devices which, according to the distance between axles, allows the distribution of the allowable weight per axle, to facilitate its transportation in an Airbus A400 or higher.

The forklift with the incorporated structural devices has the capacity to go up/down the ramp of the aeroplane, both in the stowage position in the hold of the aeroplane and in the operations of climbing/descending from the aeroplane by means of ancillary ramps, maintaining the structural integrity of the machine, without the need to use supports or props, complying with the allowable limits of maximum weight per axle and the distance between them, for which purpose, the said forklift comprises:

Detail of the distribution of weight on the rear axle:
A folding counterweight, with hydraulic drive.

Detail of the distribution of weight on the front axle:
Two intermediate brackets, attached on the right side and left side of the chassis, fixed to the mast and to the chassis by fastening means.
Two support wheels sets for coupling on the forks, and
Device for locking the carriage of the mast

### Distribution of the Weight on the Rear Axle:

The folding counterweight comprises a structure with two lower arms for coupling with lugs on the chassis, creating two pivot points, the said pivot points being fastened by bolts.

The middle zone of the counterweight incorporates a rolling block and a coupling lug for the rod head of a hydraulic drive cylinder that acts until the wheels integrated in the rolling block come into contact with the ground.

Actuation of the hydraulic cylinder is carried out by a control located on the machine or by remote control, incorporating means that allow the counterweight to be easily adapted to the aeroplane ramp when climbing or descending it.

### Distribution of the Weight on the Front Axle:

For the distribution of the weight on the front axle, the forklift comprises an intermediate bracket, positioned in a cavity on the front part of the chassis, on both the right and left sides, being coupled to the chassis and to the mast by securing means, the mast and its tilt cylinders being mounted on the said intermediate brackets.

Each intermediate bracket comprises a laminate plate of an irregular configuration, with an opening in its centre part to lighten the structural weight and make it easier to handle, a welded bracket for positioning with the chassis, placed perpendicular to the opening, incorporating bores with sleeves at its ends, distributed in the following way:
Lug, on the upper end, for coupling with the hydraulic tilt cylinder of the mast.
Lock point, on the upper zone, corresponding with the connection/disconnection of the chassis, by means of a bolt.
Pivot point on the lower end, corresponding with the attachment to the chassis
Support point, on the opposite lower end, corresponding with the attachment to the mast.

These intermediate brackets are envisaged to keep the chassis attached to the mast of the forklift in a working position, the said attachment between the chassis and the mast being able to be disconnected, when the forklift is to be transported in the hold of an aeroplane, by disconnecting the lock point of the intermediate brackets, removing the corresponding bolts, and in this way allowing the distribution of the load between the front axle and the mast.

In working conditions the forklift behaves as if the intermediate brackets do not exist, since all of the weight is shared on the front and rear axles, distributing the weights per axle according to their relative position.

Each support wheel set comprises a securing bracket and two wheels equipped with securing plates with fastening bolts with pin.

The securing brackets comprise side lugs to attach the securing plates of the wheels, incorporating, on their upper part, a bolt for locking with the forks by means of a pin.

The position of the said securing brackets is marked by a bore in the forks, where the bolt is positioned with its corresponding pin to lock the attachment. The brackets are positioned on the left side of the chassis.

The wheels, when not in use, when the forklift is in a working position, are stored in a compartment specially designed to house them, on the right side of the chassis, incorporating, next to this compartment, a ramp that is envisaged to facilitate handling the wheels.

The lock device of the carriage of the mast comprises
two sleeves located one on either side of the mast, configured with two threaded bores and
two lock brackets, located on the mast carriage, with two through-bores coinciding with the bores of the sleeves
four screws to lock the carriage of the mast, by connecting the sleeves and lock brackets after disconnecting the lock point of the intermediate brackets.

The mast loses its verticality when the lock point of the intermediate brackets is disconnected and it moves forward.

This displacement is supported by the wheel sets attached to the forks in such a way that, as they move the mast gradually recovers its verticality until the sleeves located on the mast and the lock brackets are positioned in line, in order to be able to accomplish a lock position using the corresponding screws.

Along with the air-transportable forklift referred to, a stowage procedure is developed to distribute the weight on the rear and front axle, by carrying out the following operations:

For the distribution of weight on the rear axle, the hydraulic cylinder of the counterweight is actuated until the wheels integrated in the rolling block make contact with the ground, distributing the weight supported on the rear axle between the rear axle itself and the counterweight, resulting in the weight supported on the rear axle being well below the allowable limits for the hold of the aeroplane,

For the distribution of weight on the front axle
the forks are raised to fit the securing brackets, one on each fork, by means of the corresponding lock bolt and pin,
Place the ramp against the chassis to lower the wheels manually, once they have been removed from the chassis compartment, to mount them, one on either side of the securing bracket, using the fastening bolts with their corresponding pins to lock the attachment of the support wheel sets.
The lock point of the intermediate brackets with the chassis is then disconnected, removing the corresponding bolts.
The carriage of the mast is then locked in place to prevent its displacement and to recover the verticality of the mast, by means of the sleeves on the mast coinciding with the securing brackets located on the carriage of the mast, fixed together by screws.
Once the mast has recovered its verticality, the weight supported on the front axle is distributed between the front axle itself and the mast, resulting in the weight supported on the front axle being well below the allowable limits for the hold of the aeroplane.
When the wheel sets rest on the ground, the whole front assembly, forks, carriage, mast, lifting cylinders and tilt cylinders can oscillate approximately 15° on the pivot point so that the forklift can adapt to slope changes when going up/down the aeroplane ramp.

The contents of the priority document are deemed to be included in their entirety and by reference, in the present application.

### Advantages of the Invention

The air-transportable forklift and stowage procedure presented affords the major advantage of incorporating structural devices that allow the redistribution of the weight both of the front axle and the rear axle to allow the forklift to be loaded in the hold of an aeroplane and to be transported by air, maintaining the structural integrity of the machine.

Another advantage deriving from the previous one is that the forklift is capable of climbing/descending the aeroplane ramp without requiring the use of supports or props, both in the stowage position and in the hold of the aeroplane, and in the operations of climbing and descending by means of ancillary ramps.

A person skilled in the art will easily comprehend that the characteristics of different embodiments can be combined with the characteristics of other possible embodiments, provided that the combination is technically possible.

### DESCRIPTION OF THE FIGURES

To gain a better understanding of the object of this invention, a preferred practical embodiment is shown in the drawing attached.

FIGS. 1 and 2—show a perspective view of the air-transportable forklift

FIG. 3—shows a perspective view of the forklift with the folding counterweight at ground level

FIG. 4—shows a detail of the folding counterweight

FIG. 5—shows a perspective view of the forklift with the wheel sets mounted on the fork

FIG. 6—shows a detail of the wheel set mounted on the fork

FIG. 7—is a perspective view of the intermediate bracket inserted on the chassis, with the wheel removed to observe mounting

FIG. 8—shows a construction detail of the intermediate bracket

FIG. 9—shows a perspective view of the location of the locking device of the carriage of the mast

FIG. 10—shows a construction detail of the locking device of the carriage of the mast

FIG. 11—shows a detail of the locking device in lock position

### PREFERRED EMBODIMENT OF THE INVENTION

The conformation and characteristics of the invention can be better understood in the following description that relates to the attached figures.

As can been seen in FIG. 1, the air-transportable forklift is shown in perspective, in the working position, oriented in the direction of travel, showing its left side, indicating the chassis (1), the front axle (2) with the carriage (4.1) of the mast (4), the forks (5) and indicating a bore (5.1) for attaching the support wheel sets (8).

On the side of the chassis (1) the position of the securing brackets (20) is shown and, on the front of the forklift, specifically on the carriage (4.1) of the mast (4), the lock brackets (27) of the locking device of the carriage (4.1) of the mast (4) are shown.

The rear axle (3) is shown, on which a folding counterweight (6) has been incorporated.

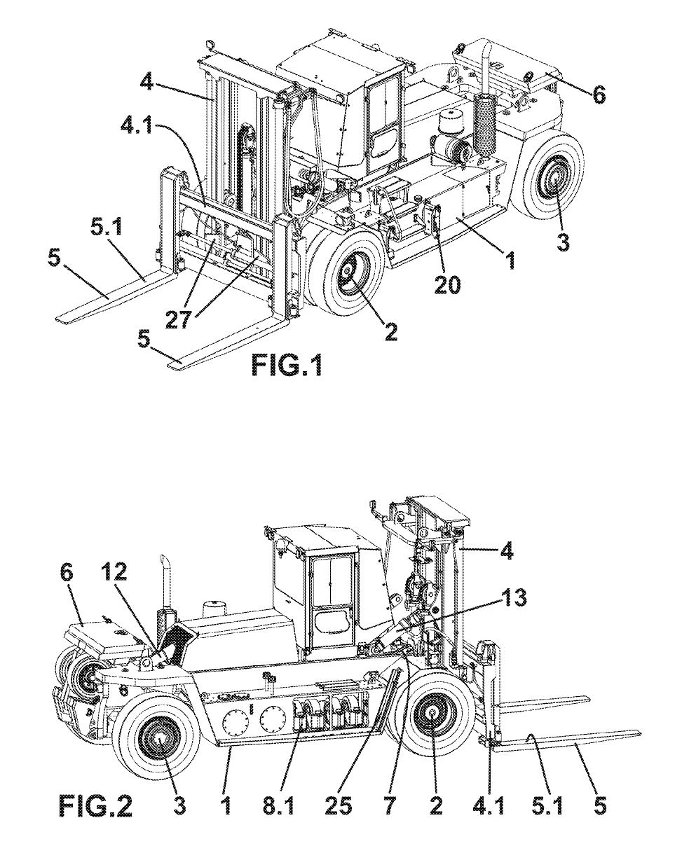

In FIG. 2 the air-transportable forklift is shown in perspective, in the working position, oriented in the direction of travel, showing its right side, indicating the chassis (1), with a compartment reserved for storing the wheels (8.1) which later form a support set (8) to support the weight distributed on the front axle (2).

Next to the aforementioned compartment, a ramp (25) intended for handling the wheels (8.1) is indicated.

On the rear axle (3) a folding counterweight (6) and an actuation hydraulic cylinder (12) are indicated and, additionally, the front axle (2) that supports the carriage (4.1) of the mast (4), the tilt cylinders (13) coupled to the mast (4) and at the opposite end, the intermediate brackets (7), inserted in a cavity in the chassis (1)

The fork (5) with a bore (5.1) intended for attaching the support wheel sets (8) is also shown.

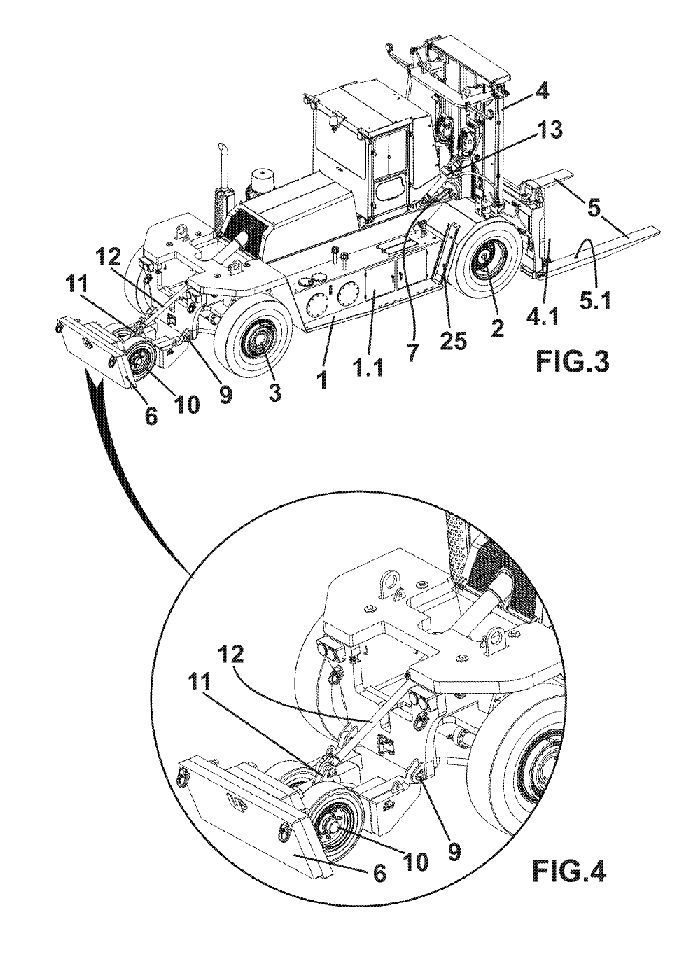

FIG. 3 shows the air-transportable forklift, in perspective, in the stowage position, oriented in the direction of travel, showing its right side, indicating the chassis (1), with a compartment (1.1.) and next to the said compartment, a ramp (25) intended for handling the wheels (8.1) stored in the said compartment.

On the rear axle (3) the counterweight (6) is shown, comprising a structure with two lower arms for coupling with lugs on the chassis (1), creating two pivot points, the said pivot points being secured by bolts (9), shown in an amplified detail in FIG. 4.

In the middle zone of the counterweight (6), a rolling block (10) is shown and a coupling lug (11) to couple the hydraulic cylinder (12) which acts until the wheels integrated in the rolling block (10) come into contact with the ground.

The actuation of the hydraulic cylinder is accomplished by a control located on the machine or by remote control, incorporating means that allow the counterweight (6) to be easily adapted to the aeroplane ramp when climbing or descending it.

The front axle (2) that supports the carriage (4.1) of the mast (4) is shown as well as the tilt cylinders (13) coupled to the mast (4) and at the opposite end, the intermediate brackets (7), inserted in a cavity in the chassis (1)

The fork (5) with a bore (5.1) intended for attaching the support wheel sets (8) is also shown.

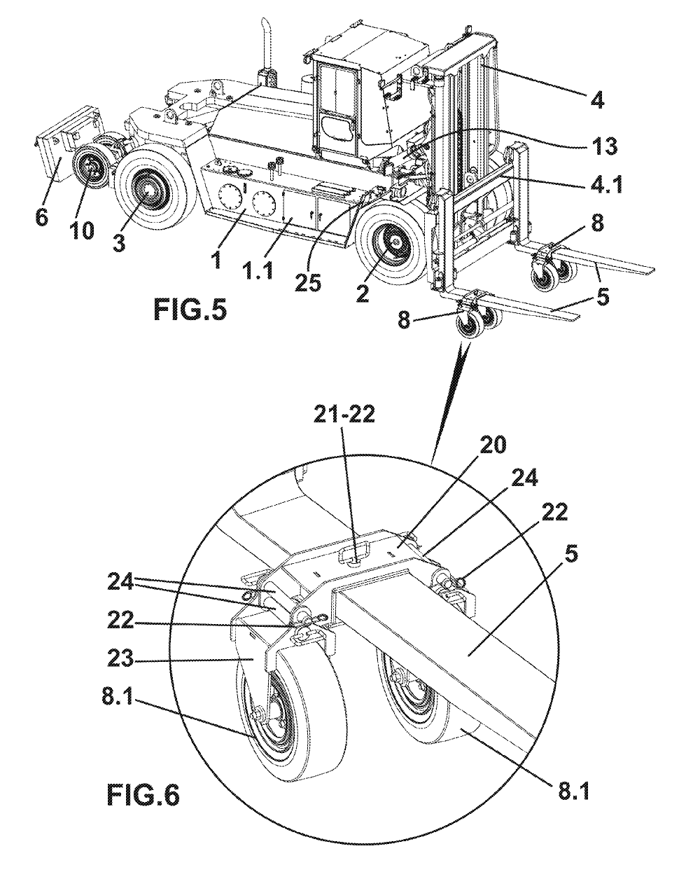

In FIG. 5 the air-transportable forklift is shown in perspective, in stowage position, oriented in the direction of travel, showing its right side, indicating the chassis (1), with a compartment (1.1) reserved for storing the wheels (8.1) to form a support set (8) mounted on the forks (5) to support the weight distributed on the front axle (2).

Next to the compartment (1.1) a ramp (25) used for handling the wheels (8.1) is shown.

On the rear axle (3) a folding counterweight (6) is shown, with the wheels of the rolling block (10) in contact with the ground, also shown is the front axle (2) that supports the carriage (4.1) of the mast (4) and the tilt cylinders (13) attached to the mast (4).

FIG. 6 shows, in perspective, the assembly of the support wheel set (8) on the forks (5), comprising a securing bracket (20) and two wheels (8.1) fitted with securing plates (23) with fastening bolts (24) with pin (22)

The securing brackets (20) are shown, being comprised by side lugs to attach the securing plates (23) of the wheels (8.1), and incorporating, on their upper part, a lock bolt (21) for locking with the forks (5) by means of a pin (22).

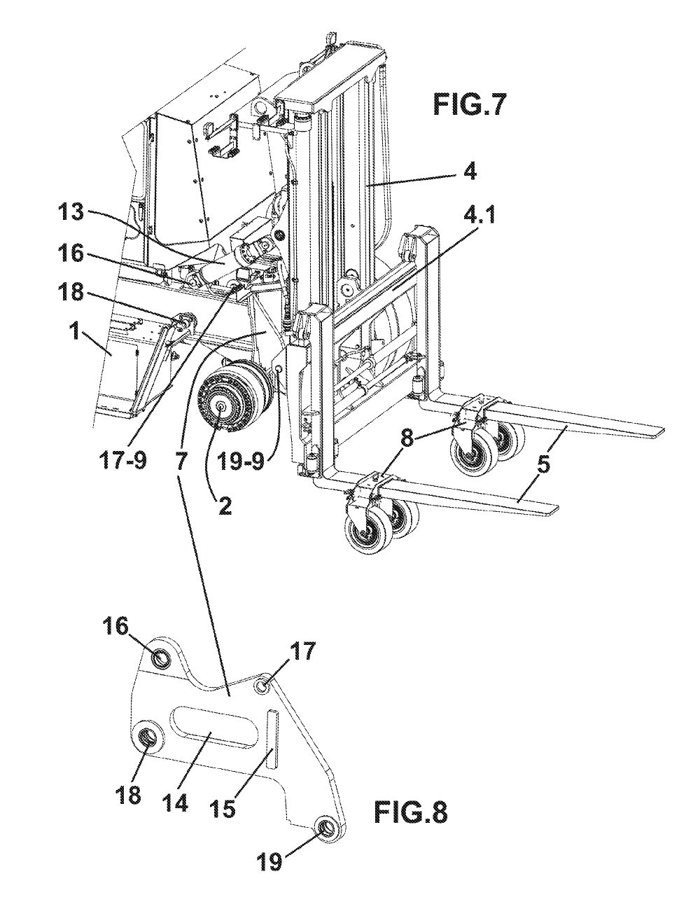

FIG. 7 shows, in perspective, the front part of the air-transportable forklift, in stowage position, oriented in the direction of travel, showing its right side, indicating the intermediate bracket (7) inserted in a cavity of the chassis (1) envisaged for the distribution of the weight of the front axle (2), being coupled to the chassis (1) and to the mast (4) by securing means, the mast (4) and tilt cylinders (13) of the same being mounted on the said intermediate supports (7).

In FIG. 7 the wheel of the front axle (2) has been eliminated to be able to observe the mounting of the intermediate bracket (7)

As shown in FIG. 8, each intermediate bracket (7) comprises a laminate plate of an irregular configuration, with an opening (14) in its centre part to lighten its structural weight and make it easier to handle, a welded bracket (15) for positioning with the chassis (1), arranged perpendicular to the opening (14), and incorporating bores with sleeves at its ends, distributed in the following way and also indicated on FIG. 7:
Lug (16), on the upper end, for coupling with the tilt cylinder (13) of the mast (4).
Lock point (17), on the upper zone, corresponding with the connection/disconnection of the chassis (1), by means of bolts (9).
Pivot point (18), on the lower end, corresponding with the attachment to the chassis (1)
Support point (19), on the opposite lower end, corresponding with the attachment to the mast (4).

The intermediate brackets (7) are intended to keep the chassis (1) attached to the mast (4) of the forklift during a working position, the said attachment being able to be disconnected, by disconnecting the lock point (17) of the intermediate brackets (7), removing the corresponding bolts (9), and in this way allowing load distribution between the front axle (2) and the mast (4)

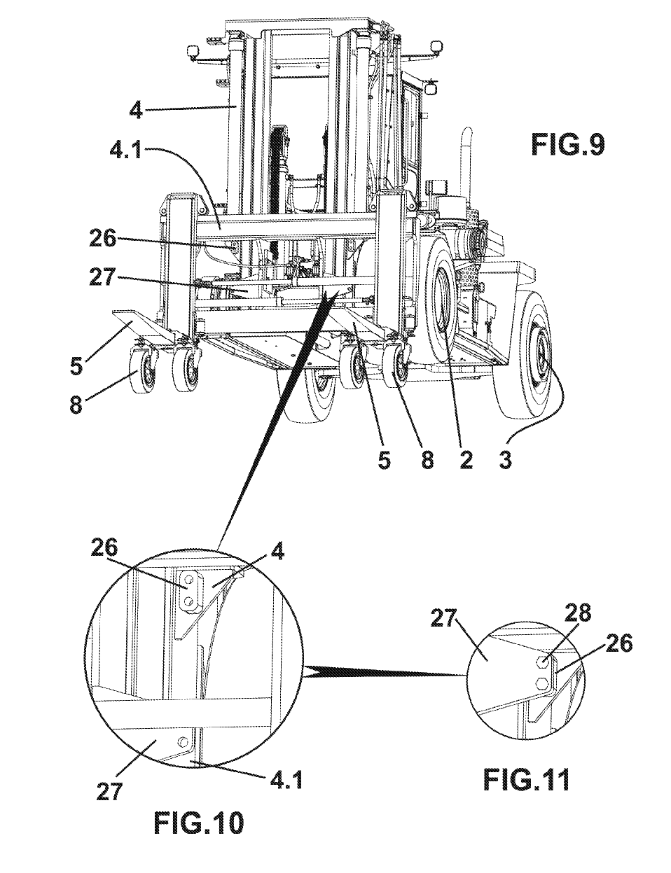

FIG. 9 shows a front perspective view of the forklift, indicating the support wheel sets (8) fixed on the forks (5), indicating, in this position, the lock device of the carriage (4.1) of the mast (4), comprising
two sleeves (26), located one on either side of the mast (4), configured with two threaded bores and
two lock brackets (27), located on the carriage (4.1) of the mast (4), with two through-bores coinciding with the bores of the sleeves (26)
four screws (28) to lock the carriage (4.1) of the mast (4) by coupling the sleeves (26) and lock brackets (27), shown in FIG. 11, after disconnecting the lock point (17) of the intermediate brackets (7),

The mast (4) loses its verticality when the lock point (17) of the intermediate brackets (7) is disconnected, producing a displacement supported by the support wheel sets (8) attached to the forks (5), in such a way that, as the mast (4) moves, it gradually recovers its verticality until the sleeves (26) located on the mast (4) and the lock brackets (27) are positioned in line, to be able to carry out a lock position by means of the corresponding screws (28), as shown in FIGS. 10 and 11.

Stowage procedure for the distribution of the weight on the rear axle (3) and front axle (2), for which the following operations are performed:

For the distribution of weight on the rear axle (3) the hydraulic cylinder (12) of the folding counterweight (6) is actuated until the wheels integrated in it make contact with the ground, distributing the weight of 13,800 kg between the rear axle (3) and the counterweight (6), the rear axle (3) being left with a maximum weight of 9,680 kg, which is below the allowable limits for the aeroplane hold, set at 10,000 kg.

For the distribution of weight on the front axle (2)
the forks (5) are raised to fit the securing brackets (20), one on each fork, by means of the corresponding lock bolt (21) and lock pin (22),
Place the ramp (25) resting against the chassis (1) to lower the wheels (8.1) manually, once they have been removed from the compartment (1.1.) of the chassis (1), to mount them, one on either side of the securing bracket (20), by means of the fastening bolts (24) with their corresponding pins (22) to lock the attachment of the support wheel sets (8).
The lock point (17) of the intermediate brackets (7) with the chassis (1) is then disconnected, removing the corresponding bolts (9).
The carriage (4.1) of the mast (4) is then locked, to prevent its displacement and to recover the verticality of the mast (4) by the sleeves (26) supported on the mast (4) coinciding with the lock brackets (27) positioned on the carriage (4.1) of the mast (4), fixed together by screws (28), once the mast (4) recovers verticality, distributing the weight of 15,000 kg between the front axle (2) and the mast (4), the front axle (2) being left with a maximum weight of 9,600 kg, which is below the allowable limits for the aeroplane hold, set at 10,000 kg.
When the support wheel sets (8) rest on the ground, the whole front assembly, fork (5), carriage (4.1), mast (4), lifting cylinders and tilt cylinders can oscillate on the pivot point (18) approximately 15° so that the forklift can adapt to slope changes when climbing/descending the aeroplane ramp.

1. Air-transportable forklift, basically comprising a chassis (1) with a front axle (2), a rear axle (3) and a mast (4) with forks (5), characterised in that it incorporates
As elements for the distribution of weight on the rear axle (3)
A folding counterweight (6), hydraulically actuated, by manual control or remote control.
As elements for the distribution of weight on the front axle (2)
Two intermediate brackets (7), inserted in a cavity of the chassis (1) on both sides, fixed to the mast (4) and to the chassis (1) by securing means.
Two support wheels sets (8), for coupling on the forks (5), and
Lock device of the carriage (4.1) of the mast (4).

2. Air-transportable forklift, according to claim 1, wherein the folding counterweight (6) comprises a structure with two lower arms for coupling with lugs on the chassis (1), creating two pivot points by means of bolts (9), incorporating in its middle zone a rolling block (10), and a coupling lug (11) for coupling an actuation hydraulic cylinder (12).

3. Air-transportable forklift, according to claim 1, wherein each intermediate bracket (7) comprises a laminate plate of an irregular configuration, with an opening (14) in its centre part, a welded bracket (15) for positioning with the chassis (1), arranged perpendicular to the opening (14), incorporating at its ends, bores with sleeves distributed in the following way:
Lug (16), on the upper end, for coupling with the tilt cylinder (13) of the mast (4).
Lock point (17), on the upper zone, corresponding with the connection/disconnection of the chassis (1), by means of bolts (9).
Pivot point (18), on the lower end, corresponding with the attachment to the chassis (1)
Support point (19), on the opposite lower end, corresponding with the attachment to the mast (4).

4. Air-transportable forklift, according to claim 1, wherein each support wheel set (8), comprises a securing bracket (20), located on the left side of the chassis (1) and two wheels (8.1) equipped with securing plates (23) with fastening bolts (24) with pin (22), the said wheels (8.1) being located in a compartment (1.1) on the right side of the chassis (1).

5. Air-transportable forklift, according to claim 1, wherein each securing bracket (20) comprises side lugs for the attachment of the securing plates (23) of the wheels (8.1) incorporating on their upper part, a lock bolt (21) for coupling with a bore (5.1) made in the forks (5), fixing the position with a pin (22).

6. Air-transportable forklift, according to claim 1, wherein on the right side of the chassis (1) a ramp (25) is incorporated, facilitating the handling of the wheels.

7. Air-transportable forklift, according to claim 1, wherein the lock device of the carriage (4.1) of the mast (4), comprises:
two sleeves (26), located one on either side of the mast (4), configured with two threaded bores and
two lock brackets (27), located on the carriage (4.1) of the mast (4), with two through-bores coinciding with the bores of the sleeves (26)
four screws (28) for locking, by means of the coupling of the sleeves (26) with the lock brackets (27).

8. Stowage procedure of an air-transportable forklift, as described in claim 1, wherein the allowable weight per axle is distributed according to the distance between them, and preserving the structural integrity of the machine, by a distribution of the weight on the rear axle (3) and a distribution of the weight on the front axle (2).

9. Stowage procedure of an air-transportable forklift, according to claim 8 wherein for the distribution of weight on the rear axle (3), the hydraulic cylinder (12) of the folding counterweight (6) is actuated until the wheels integrated in the rolling block (10), make contact with the ground, distributing the weight supported on the rear axle (3), between the rear axle (3) and the folding counterweight (6).

10. Stowage procedure of an air-transportable forklift, according to claim 8, wherein for the distribution of weight on the front axle (2),
the forks (5) are raised to place the support wheel sets (8) on them
The lock point (17) of the intermediate brackets (7) with the chassis (1) is then disconnected, removing the corresponding bolts (9).
The carriage (4.1) of the mast (4) is then locked, by means of the coupling between the sleeves (26) and the lock brackets (27), aligned and fixed together by screws (28), recovering the verticality of the mast (4), the weight supported on the front axle (2) being distributed between the front axle (2) itself and the mast (4).
